(19) United States
(12) Patent Application Publication
(10) Pub. No.: US 2025/0380683 A1
(43) Pub. Date: Dec. 18, 2025

(54) Prediator

(71) Applicant: Keni Lyn Anderson, Newark, DE (US)

(72) Inventor: Keni Lyn Anderson, Newark, DE (US)

(21) Appl. No.: 18/831,080

(22) Filed: Jun. 17, 2024

(51) Int. Cl. A01M 29/24; A01K 15/02

(52) U.S. Cl. CPC A01M 29/24; A01K 15/029

(57) ABSTRACT

The Prediator has an innovative combination of existing technologies that will save lives, time, effort, and monetary loss. It will also prevent the emotional devastation which often occurs with the loss of a domestic animal. By arming animals with sensors capable of discerning a predator, and enabling a protective, non-lethal electrical discharge—both animals and their stewards will benefit.

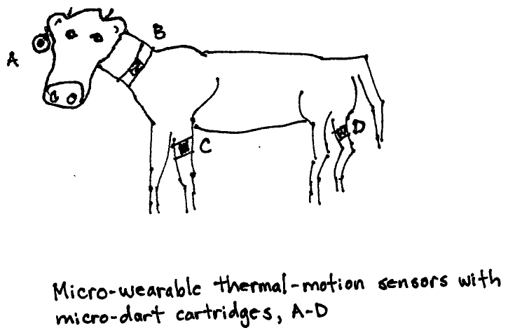

Background—The Prediator was invented in a response to protect animals, both domestic and agricultural.

Drawing—The Drawing is basic, with the utilized and additional technologies displayed on a model animal.

The Prediator uses thermal and motion detecting micro-sensor wearables to discern between predators and non-predators. Additional safety features include biometrics to prevent unwanted discharge of electrical emissions.

Once a predator is established, electrical discharge emissions are dispersed in a targeted manner via darts causing neuromuscular incapacitation. Supplemental micro-sensors will also be positioned on inanimate objects such as buildings and fence posts.

Auditory detection and discrimination technology is also used regarding predator noise. Alarms of choice [silent visual and/or calibrated decibels] deploy, followed by disabling sounds emitted via a micro-tower and speakers.

Micro wearables will be manufactured with a low density polyethylene plastic containing the micro sensors. Sensors will be modified from an existing technology patented by SimpliSafe® The conducted electrical weapon will be modified from existing patented Taser® technology. Additional technology [e.g. an application program for mobile monitoring] will be added.

This patent is requested because there is not currently any system designed to protect domestic and agricultural animals without direct human intervention. Certain agricultural animals are in remote areas which can cause hardship regarding human monitoring. The problem of range animals and predators can be nearly eliminated with the negative reinforcement feature of the electrical discharge discouraging return contact. Both domestic and agricultural animals can be safe and secured with the biometrics feature only allowing certain persons to approach and/or move the animal.

1. Micro-wearables containing micro thermal and motion sensors attached to animals that deploy electrical emissions via darts upon the identification of a target predator are a unique invention. This invention, The Prediator, is designed to protect animals, and provide them with a defense mechanism in the absence of human intervention.
